(19) United States
(12) Patent Application Publication
(10) Pub. No.: US 2011/0115358 A1
(43) Pub. Date: May 19, 2011

(54) LED BULB HAVING SIDE-EMITTING LED MODULES WITH HEATSINKS THEREBETWEEN

(75) Inventor: Steven KIM, Riverdale, NJ (US)

(73) Assignee: LED FOLIO CORPORATION, Riverdale, NJ (US)

(21) Appl. No.: 12/618,996

(22) Filed: Nov. 16, 2009

(51) Int. Cl. H01J 61/52

(52) U.S. Cl. 313/46

(57) ABSTRACT

Disclosed is a LED bulb having side-emitting LED modules with heatsinks therebetween which includes a base member having a first surface and a second surface, an electrical connector at the first surface of the base member, a plurality of light emitting diode modules stacked on the second surface, wherein each of the light emitting diode modules have top surface on which a plurality of light emitting diodes are positioned and a bottom surface opposite to the top surface, and a plurality of heatsinks positioned between every other one of the plurality of light emitting diode modules.

### BACKGROUND OF THE INVENTION

1. Field of the Invention

The embodiments of the invention relate to a light emitting diode (hereinafter “LED”) bulb, and more particularly, to an LED bulb Having side-emitting LED modules therebetween. Although embodiments of the invention are suitable for a wide scope of applications, they are particularly suitable for lighting applications that can otherwise use compact fluorescent bulbs or incandescent bulbs.

2. Discussion of the Related Art

In general, the LED bulb is more energy efficient than either an incandescent bulb or a compact fluorescent bulb. An incandescent bulb converts about 3 percent of the supplied power into light at about 14-16 lumens/watt. A compact fluorescent bulb converts about 12% of the supplied power into light at about 60-72 lumens/watt. An LED bulb converts about 18% of the supplied power into light at about 93-95 lumens/watt. The rest of the supplied power for each of the incandescent bulb, the compact fluorescent bulb and the LED bulb is usually expended as heat.

An incandescent bulb uses a filament to create light. A compact fluorescent bulb uses a gas excited by an electric field to create light. An LED bulb uses one or more LEDs in which each of the LEDs uses a semiconductor chip to create light. Because the LED bulb uses a semiconductor chip, the LED bulb can have a much longer life-span than either an incandescent bulb or a compact fluorescent bulb.

The heat expended from the LED of an LED bulb is generated inside the semiconductor chip adjacent to the junction of different types of semiconductor materials. As the temperature rises in the semiconductor chip of an LED in the LED bulb, the light conversion efficiency can actually decrease as the input power is increased. Also, as the semiconductor chip of an LED is exposed to long periods of high temperatures, the life-span of the LEDs within the LED bulb decrease and/or the brightness of the LEDs within the LED bulb permanently drops.

Because heat is generated within the semiconductor chip of an LED, heat must be conducted out of the semiconductor chip via a path of low heat resistance. Such heat conduction or heat dissipation keeps the LED chip at a nominal temperature such that the LED will function most efficiently and have a long term life-span. A heat sink is typically used to conduct or dissipate heat away from the LED(s) in an LED light bulb.

Incandescent bulbs come in different light output capabilities, different shapes, different sizes and different types of screw-in type electrical connections. Although a compact fluorescent bulb is a completely different light technology than the incandescent bulb, compact fluorescent bulbs have been manufactured to have many of the same light output capacities as well as the same size, shape and screw-in type electrical connections as incandescent bulbs. Attempts have been made to do the same with LED bulbs but the need for heatsinks has made such previous LED bulbs with vast areas of fins at which no light is produced. Also, previous LED bulbs have provided unidirectional light or poorly dispersed light in comparison to an incandescent bulb or a compact fluorescent bulb. More particularly, light from previous LED bulbs is generally only emitted from the top of the bulb.

### SUMMARY OF THE INVENTION

Accordingly, embodiments of the invention are directed to an LED bulb having side-emitting LED modules with heatsinks therebetween that substantially obviates one or more of the problems due to limitations and disadvantages of the related art.

An object of embodiments of the invention is to provide an LED bulb that uniformly disperses light from the side of the LED bulb.

Another object of embodiments of the invention is to provide an LED bulb that dissipates heat from each of the LEDs.

Another object of embodiments of the invention is to maintain the efficiency of LEDs in an LED bulb.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a LED bulb having side-emitting LED modules with heatsinks therebetween includes a base member having a first surface and a second surface, an electrical connector at the first surface of the base member, a plurality of light emitting diode modules stacked on the second surface, wherein each of the light emitting diode modules have top surface on which a plurality of light emitting diodes are positioned and a bottom surface opposite to the top surface, and a plurality of heatsinks positioned between every other one of the plurality of light emitting diode modules.

In another aspect, the light emitting diode bulb includes a base member having a first surface and a second surface, an electrical connector at the first surface of the base member, a pillar extending from the second surface of the base member, a plurality of light emitting diode modules stacked on the base member and surrounding the pillar, wherein each of the light emitting diode modules have top surface on which a plurality of light emitting diodes are positioned and a bottom surface opposite to the top surface, and a plurality of heatsinks respectively positioned on the bottom surfaces of pairs of the plurality of light emitting diodes.

In yet another aspect, a light emitting diode bulb includes a base member having a first surface and a second surface, an electrical connector at the first surface of the base member, a first light emitting diode module connected at the second surface and having a first outer periphery, a first plurality of side-emitting light emitting diodes at the first outer periphery, a second light emitting diode module stacked on the first light emitting diode module and having a second outer periphery, a second plurality of side-emitting light emitting diodes at the second outer periphery and facing opposite to the first plurality of side-emitting light emitting diodes, a first heatsink on the first light emitting diode module, a second heatsink on the second light emitting diode module, and a first diffuser between the first and second heatsinks.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an assembly view of an LED bulb according to an exemplary embodiment of the invention;

FIG. 2 is a side view of a LED bulb according to an exemplary embodiment of the invention;

FIG. 2b is a side view of an LED module;

FIG. 3 is a cross-sectional view of an LED bulb according to an exemplary embodiment of the invention;

FIG. 4 is a cross-sectional view of an LED bulb showing air flow according to the an exemplary embodiment of the invention;

FIG. 5a is a top view of an LED module;

FIG. 5b is a side view of an LED module;

FIG. 6 is an assembly view of an LED module;

FIG. 7a is a top view of a circuit board with parallel connected LEDs;

FIG. 7b is a bottom view of a circuit board with parallel connected LEDs;

FIG. 8a is a top view of a circuit board with groups of serially connected LEDs;

FIG. 8b is a bottom view of a circuit board with groups of serially connected LEDs;

FIG. 9 is a side view of a LED bulb according to an exemplary embodiment of the invention;

FIG. 10 is a side view of a LED bulb according to an exemplary embodiment of the invention;

FIG. 11 is a side view of a LED bulb according to an exemplary embodiment of the invention;

FIG. 12 is a cross-sectional view of an LED bulb showing air flow according to an exemplary embodiment of the invention; and

FIG. 13 is an isometric cross-sectional view of a light diffuser shown in FIG. 12.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

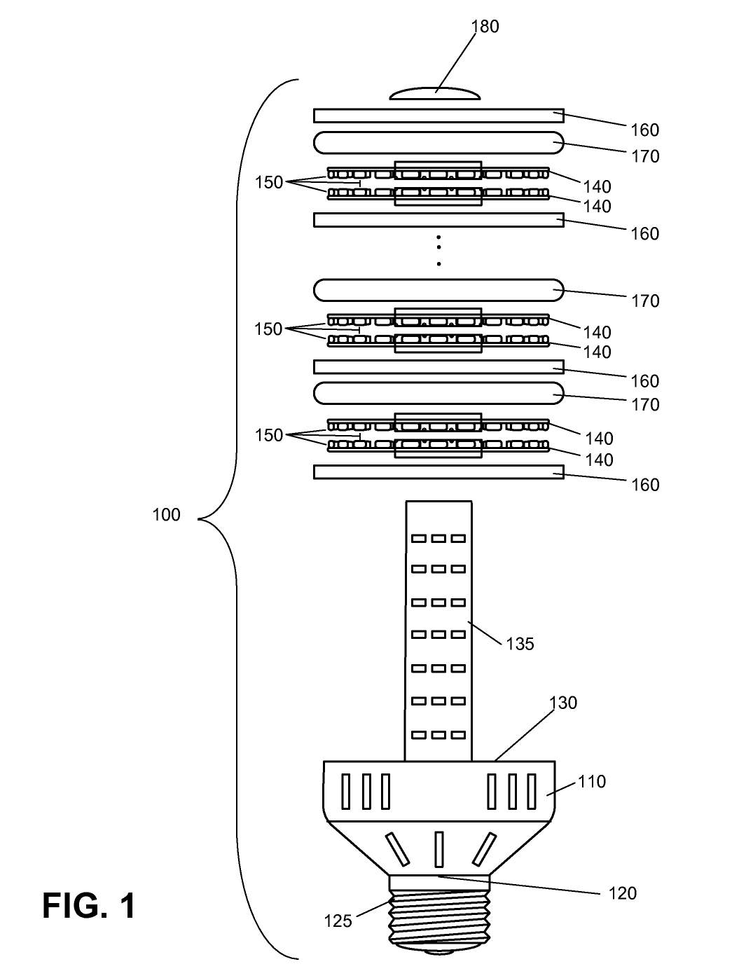

FIG. 1 is an assembly view of an LED bulb according to an exemplary embodiment of the invention. As shown in FIG. 1, an LED bulb 100 has a base 110 with a first surface 120 and a second surface 130. An electrical connector 125 is located on the first surface 120. A plurality of LED modules 140 are stacked on the second surface 130 with a heatsink between separate pairs of LED modules 140. Each of the LED modules 140 is populated with a plurality of side-emitting LEDs 150. The heatsinks 160 are used to facilitate heat transfer from LED modules. Light diffusers 170 cover the LED modules 140 to diffuse the light from the plurality of LEDs 150. More specifically, each of the light diffusers 170 surrounds a pair of the plurality of side-emitting LEDs 150. In this embodiment, a pillar 135 is attached to the second surface 130. The pillar 135 can serve as an attachment point and stabilization structure for the plurality LED modules 140. The pillar 135 can also serve as a chimney for heat generated by the LED bulb 100 by removing heat from the heat sinks through the wall of the pillar 135. A cap 180 secures the LED modules, diffusers, and heat sinks onto the pillar 135. The assembled LED bulb 100 can be somewhat similar in size and shape to a typical incandescent bulb or a typical compact fluorescent bulb.

The heatsinks 160 can be made from a material that is not electrically conductive to prevent electrical continuity between adjacent LED modules through the heatsink. Alternatively, a heatsink can be made from an electrically conductive material such as copper, aluminum, or steel that is then sheathed in a thin layer of thermally conductive but not electrically conductive material as mica or aluminum nitride. Heatsinks can conduct heat from the LED modules by direct contact with the LED modules. Alternatively, heatsinks and LED modules can be joined using thermal paste to increase the thermally conductive surface area. Thermal paste can contain thermally conductive ceramic compounds such as beryllium oxide, aluminium nitride, aluminum oxide, zinc oxide, or silicon dioxide. Thermal paste can also contain thermally conductive metal or carbon compounds such as silver, aluminum, liquid gallium, diamond powder, or carbon fibers. The thermal paste can use silicone as a medium to suspend the thermally conductive materials.

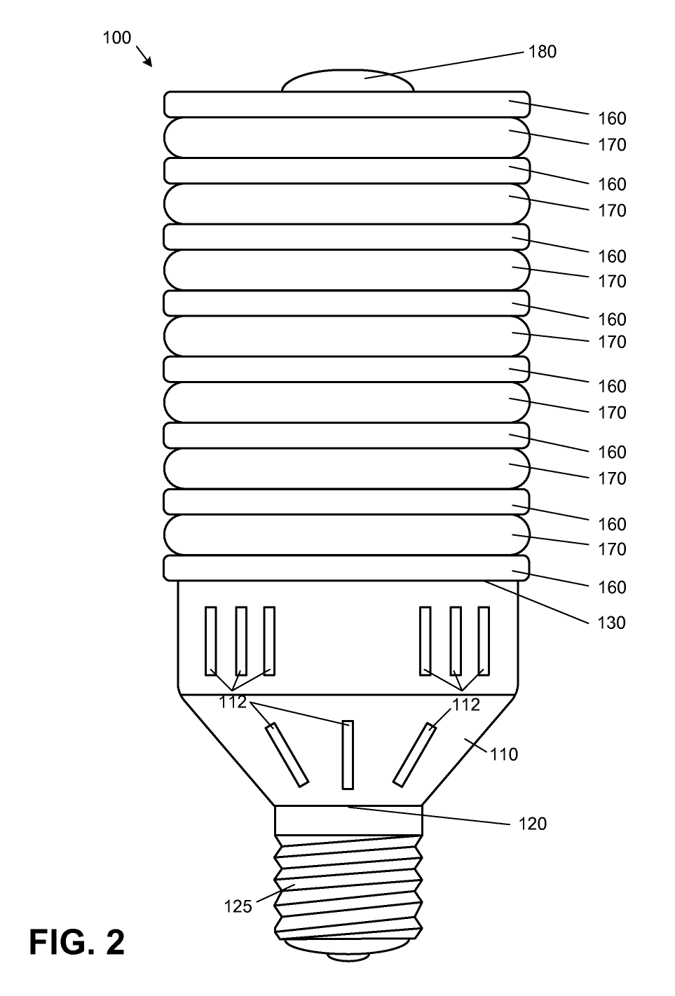

FIG. 2 is a side view of a LED bulb according to an exemplary embodiment of the invention. As shown in FIG. 2, an LED bulb 100 has a base 110 with a first surface 120, a second surface 130, and vent holes 112. An electrical connector 125 is located on the first surface 120. A plurality of LED modules (not shown) are stacked on the second surface 130 behind light diffusers 170. Each of the LED modules is populated with a plurality of side-emitting LEDs (not shown). Heatsinks 160 between separate pairs of the LED modules are used to facilitate heat transfer from LED modules. Light diffusers 170 cover the LED modules (not shown) to diffuse the light from the plurality of LEDs (not shown).

The light diffusers 170 have about the same diameter as the heatsinks 160. This aids in the aesthetics of the LED bulb by providing a smooth contoured shape. The light diffusers 170 can be either translucent or transparent. For example, a translucent light diffusers 170 can have a diffusion coating on the inside surface and/or outside surface of the cover to diffuse the light emitted from the side-emitting LEDs of the LED modules. In another example, a translucent light diffusers 170 can have a phosphor coating on the inside surface and/or outside surface of the cover to convert ultraviolet light emitted from the side-emitting LEDs of the LED modules into visible light.

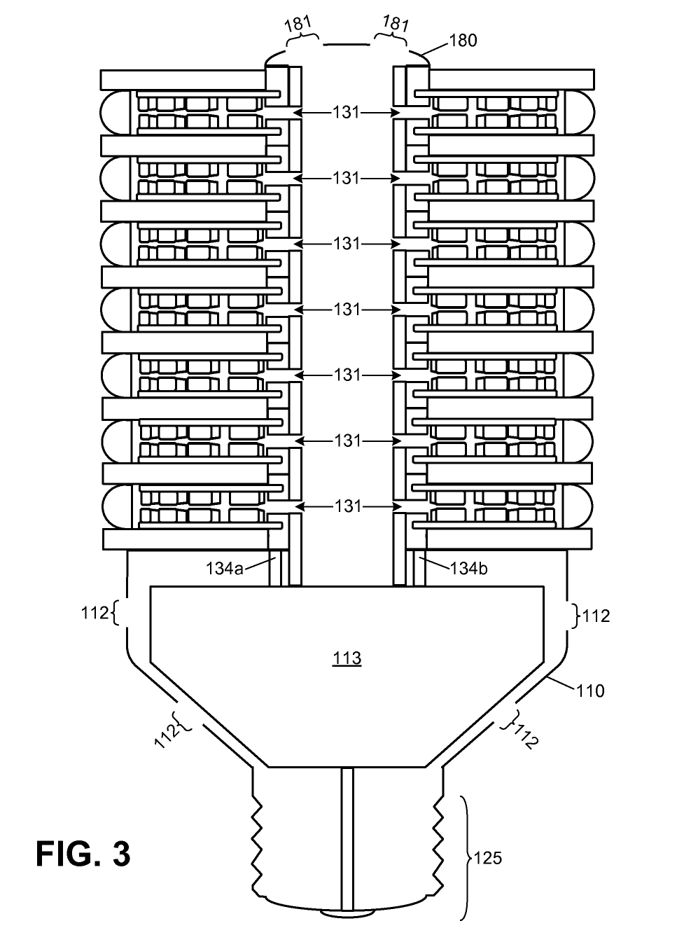

FIG. 3 is a cross-sectional view of an LED bulb according to an exemplary embodiment of the invention. As shown in FIG. 3, the base 110 houses a power converter 113 that converts alternating current voltage from the screw-in type electrical connector 125 into direct current voltage. The power converter 113 provides the direct current voltage to the interboard connectors 144 through electrical leads 134a and 134b.

The pillar 30 has openings 131 that correspond to gaps between the pairs of LED modules which allow for the flow of heated air from the LED modules, into the pillar 30 and out of the top of the LED bulb through vents 181 in the cap 180.

In addition to the openings 112 in the sides of the base 110 between the pillar 30 and the screw-in type electrical connector 125, the base 110 also has openings (not shown) in the side of the base 110 from which the pillar 30 extends. The openings 112 in the base 110 facilitate air flow through the base 110 to cool the power converter 113. A screen or filter can be provided across the openings 112 in the base 110 to prevent dust intrusion into area within the base 110 containing the power converter 113.

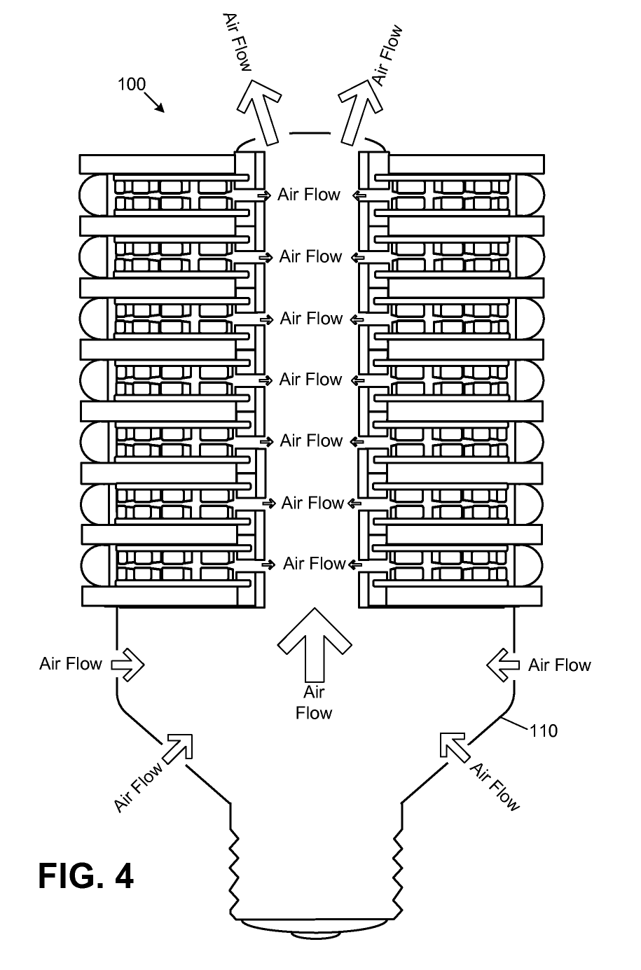

FIG. 4 is a cross-sectional view of an LED bulb showing air flow according to the an exemplary embodiment of the invention. As shown in FIG. 4, the openings in the base 110 allow air movement through the base such that the LED modules can be cooled. Although the air flow is shown going through the base 110 and then into the LED module area in the LED bulb 100 shown in FIG. 4, the air flow would go through the LED module area and then into the base 110 when the LED bulb 100 is implemented upside down due to the convection current nature of heated air.

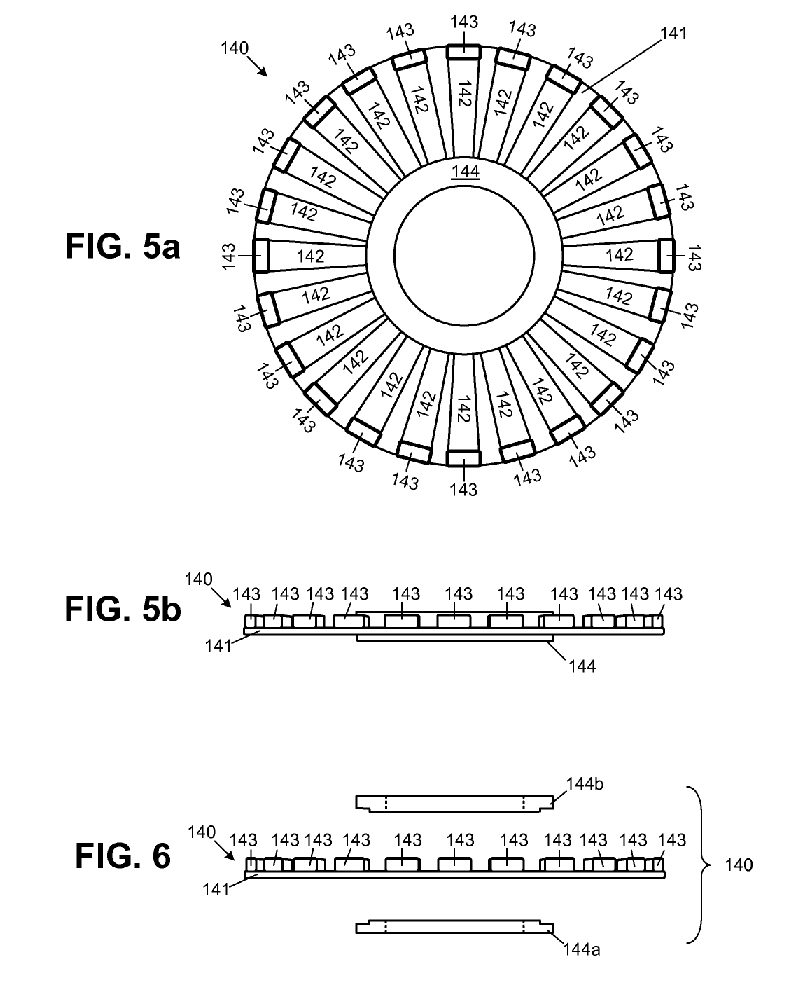

FIG. 5a is a top view of an LED module and FIG. 5b is a side view of an LED module. As shown in FIG. 5a, an LED module 140 includes a circuit board 141 with electrical traces 142, side-emitting LEDs 143 mounted on the circuit board at one end of the electrical traces 142, and interboard connector 144 at the other end of the electrical traces 142. Heat generated by the side-emitting LEDs 143 can be transferred through the electrical traces 142 to the interboard connector 144. Further, heat being transferred into the electrical traces 142 from the side-emitting LEDs can be radiated into the air by the electrical traces 142.

The side-emitting LEDs 143 are electrically connected to the electrical traces 142. The interboard connector 144 has conductors (not shown) that connect to the electrical traces 142 and run to the upper and lower surfaces of the interboard connector 144 such that direct current voltage can be supplied to the side-emitting LEDs 143 of an LED module 140 from an adjoining interboard connector or a power converter. Thus, the conductors (not shown) of the interboard connector 144 are configured such that a plurality of LED modules can be stacked upon each other and adjoining interboard connectors will provide direct current voltage to all of the side-emitting LEDs in the stack of LED modules.

As shown in FIG. 5b, the interboard connector 144 extends above and below the circuit board 141 of the LED module 140. Upon stacking a plurality of LED modules 140, only the interboard connector 144 of each LED module 140 contacts the interboard connector 144 of another LED module 140. Thus, the interboard connector 144 provides a spacing or gap between the circuit boards 141 and the side-emitting LEDs 143 of adjacent LED modules 140.

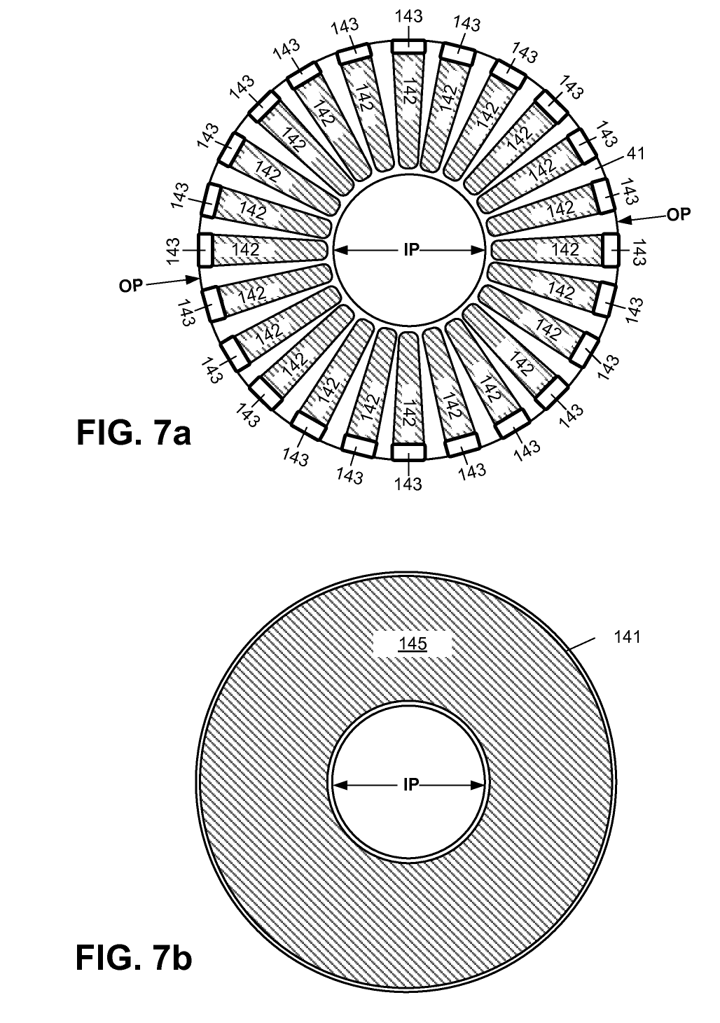

FIG. 6 is an assembly view of an LED module. As shown in FIG. 6, interboard connector 144 can have a lower portion 144a and a top portion 144b that are joined together onto the electrical traces 142 of the circuit board 141. By assembling the lower and upper portions 144a and 144b of the interboard connector 144 onto the circuit board 141, the interboard connector 144 provides spacing between LED modules 140, power to the side-emitting LEDs 143 of the modules 140 through the electrical traces 142 and receives heat from the side-emitting LEDs 143 through the electrical traces 142.

FIG. 7a is a top view of a circuit board with parallel connected LEDs and FIG. 7b is a bottom view of a circuit board with parallel connected LEDs. As shown in FIG. 7a, a circuit board 141 has an inner periphery IP and an outer periphery OP. Electrical traces 142 on the circuit board 141 have a radial pattern running from the inner periphery IP to the outer periphery OP of the circuit board 141. The electrical traces 142 are relatively wide such that heat from the side-emitting LEDs 143 transferred into the electrical traces 142 can be radiated into the air. As shown in FIG. 7b, a backplane electrode 145 covers most of the side of the circuit board 141 opposite to the side having the radial electrical traces 142.

The LEDs 143 at the outer periphery of the circuit board 141 are side-emitting LEDs in that light generally emanates from the LEDs 143 in the same radial direction as the electrical trace on which an LED is mounted. The light of the side-emitting LEDs 143 is directed outward away from the circuit board 141 such that light is not directed at another circuit board when modules including the circuit boards are stacked, as shown in FIG. 1. By using side-emitting LEDs 143, which generally emit light in radial direction away from the circuit board 141, light efficiency is improved since all light is generally emitted in direction through the cover 147 when modules including the circuit boards are stacked, as shown in FIG. 1.

The side-emitting LEDs 143 are two terminal devices in which one terminal of each of the side-emitting LEDs 143 is connected one of the electrical traces 142. The other terminal of each of the side-emitting LEDs 143 is connected to the backplane electrode 145 on the other side of the circuit board 141, as shown in FIG. 7a. Because the side-emitting LEDs 143 are respectively connected to the electrical traces 142 and commonly connected to the backplane electrode 145, the side-emitting LEDs 143 can be supplied direct current voltage in parallel to each other. An electrical failure in one LED on the circuit board 141 of parallel connected LEDs will not effect the operation of the other LEDs on the circuit board 141.

The electrical traces 142 and the backplane electrode 145 are formed of a metal or a metal alloy, such as aluminum or a copper alloy. The metal or metal alloy dissipates heat from the side-emitting LEDs 143 and transfers heat from the side-emitting LEDs 143 into the air and the adjacent heatsinks (not shown). Although the backplane electrode 145 does not directly receive heat transfer from the side-emitting LEDs 143, the backplane electrode 145 can absorb heat through the circuit board 141 and radiate that heat into the air or the heatsink.

The side-emitting LEDs 143 at the outer periphery OP of the circuit board can be less than a half of a watt, such as 0.064 watt. Typically, LEDs designed to output light at less than a half of a watt have a higher energy to light conversion efficiency than LEDs designed to output light at greater than a half of a watt. For example, if the twenty four side-emitting LEDs 143 in FIG. 7a were 0.064 watt side-emitting LEDs such that the sum power usage is about 1.5 watts, the twenty four 0.064 watt side-emitting LEDs would have higher light output than a single 1.5 watt LED. In such an example, the single 1.5 watt LED would also require a large unsightly external heatsink as opposed to the twenty four 0.064 watt side-emitting LEDs 143 that use electrical traces 142 and integrated heatsinks.

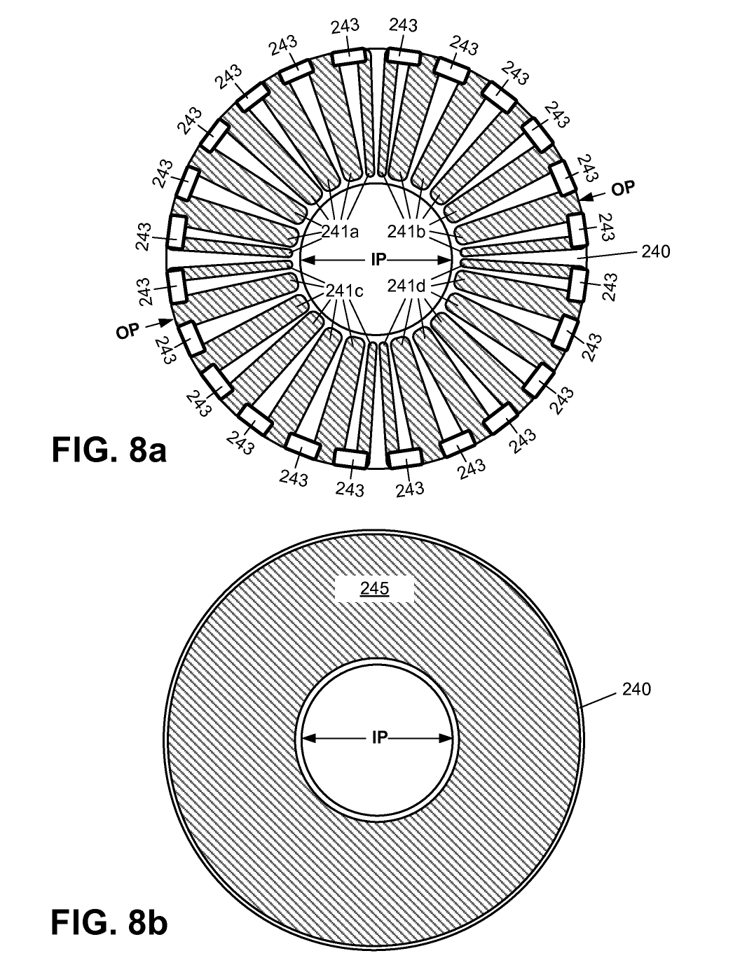

FIG. 8a is a top view of a circuit board with groups of serially connected LEDs and FIG. 8b is a bottom view of a circuit board with groups of serially connected LEDs. As shown in FIG. 8a, a circuit board 240 has groups of electrical traces 241a, 241b, 241c and 241d in a radial pattern. Side-emitting LEDs 243 are mounted on the circuit board at the ends of the groups of radial electrical traces 241a, 241b, 241c and 241d near the outer periphery OP of the circuit board 240. As shown in FIG. 8b, a backplane metal 245 covers most of the side of the circuit board 240 opposite to the side having the groups of radial electrical traces 241a, 241b, 241c and 241d.

The side-emitting LEDs 243 are two terminal devices in which each terminal is respectively connected to a different electrical trace within a group such that LEDs connected to a group of electrical traces are connected in series. The backplane metal 245 is not used for electrical purposes but still serves as a heat radiator for the side-emitting LEDs 243 through the circuit board 24. A direct current voltage is provided to each of the serial connected groups of LEDs in parallel. An electrical failure in one serially connect group of LEDs connected in parallel to other groups of LEDs will not effect the operation of the other groups of LEDs. Using groups of serially connected LEDs on the circuit board 240 reduces the number and complexity of conductors in the interboard connectors used with the circuit boards to make LED modules.

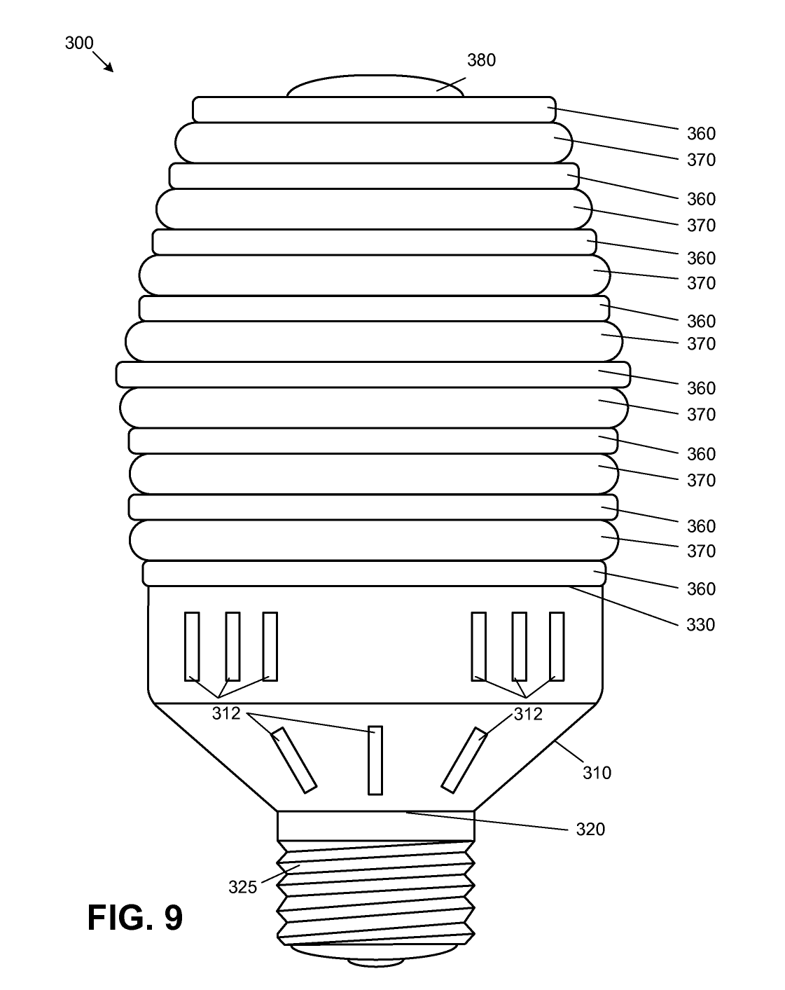

FIG. 9 is a side view of a LED bulb according to an exemplary embodiment of the invention. As shown in FIG. 9, an LED bulb 300 has a base 310 with a first surface 320, a second surface 330, and vent holes 312. An electrical connector 325 is located on the first surface 320. The electrical connector 325 can be an Edison E27 screw-in type connector. A plurality of LED modules (not shown) are stacked on the second surface 330 with a heatsink 360 between separate pairs of LED modules behind light diffusers 370. Heatsinks 360 are used to facilitate heat transfer from LED modules. Light diffusers 370 cover the LED modules (not shown) to diffuse the light from the plurality of LEDs (not shown). More specifically, each of the light diffusers 370 surrounds a pair of the plurality of side-emitting LEDs. In this embodiment, a pillar (not shown) is attached to the second surface 330. A pillar (not shown) can serve as an attachment point and stabilization structure for the plurality of LED modules and the heatsinks 360. The pillar can also serve as a chimney for heat generated by the LED bulb 300 by removing heat from the heat sinks through the wall of the pillar. A cap 380 secures the LED modules, diffusers 370, and heatsinks 360 onto the pillar. The assembled LED bulb 300 can be somewhat similar in size and shape to a typical incandescent bulb or a typical compact fluorescent bulb.

The light diffusers 370 can be either translucent or transparent. For example, a translucent light diffusers 370 can have a diffusion coating on the inside surface and/or outside surface of the cover to diffuse the light emitted from the side-emitting LEDs of the LED modules. In another example, a translucent light diffusers 370 can have a phosphor coating on the inside surface and/or outside surface of the cover to convert ultraviolet light emitted from the side-emitting LEDs of the LED modules into visible light.

As shown in FIG. 9, the LED bulb 300 contains a plurality of modules in which at least some the LED modules have different diameters and a different number of side-emitting LEDs. For example, an LED bulb may first have some LED modules that are about three inches wide with twenty-four side-emitting LEDs and modules with successively decreasing numbers of side-emitting LEDs and successively decreasing diameters down to an LED module that is about one inch wide with six side-emitting LEDs.

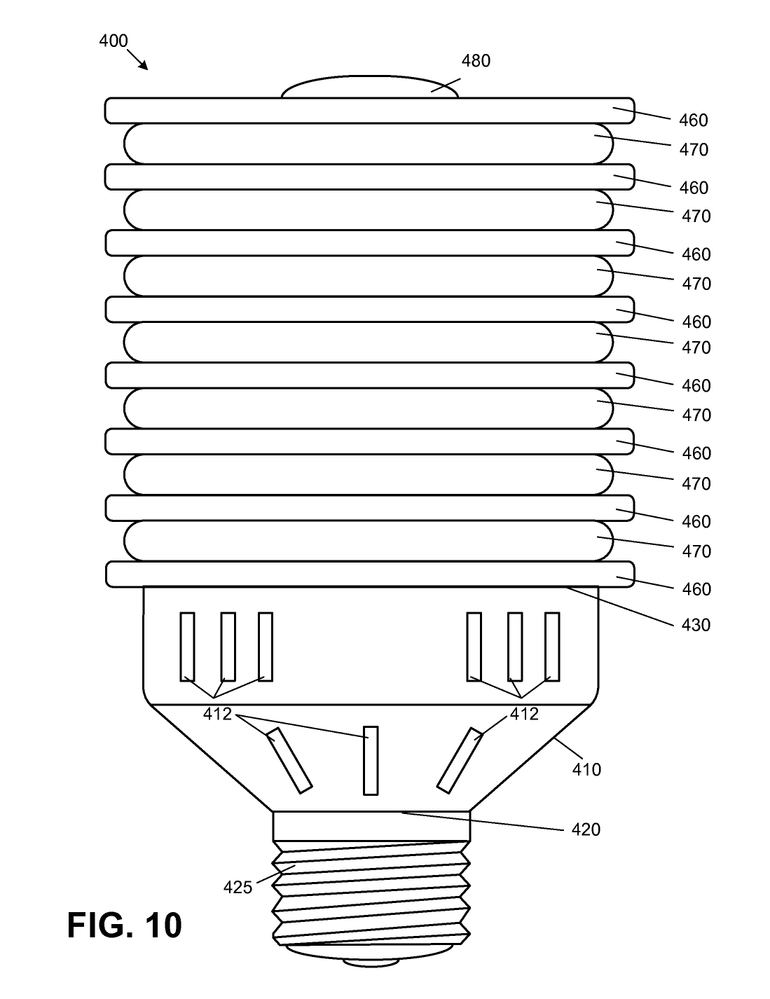

FIG. 10 is a side view of a LED bulb according to an exemplary embodiment of the invention. As shown in FIG. 10, an LED bulb 400 has a base 410 with a first surface 420, a second surface 430, and vent holes 412. An electrical connector 425 is located on the first surface 420. The electrical connector 425 can be an Edison E27 screw-in type connector. A plurality of LED modules (not shown) are stacked on the second surface 440 with a heatsink between separate pairs of LED modules behind light diffusers 470. Each of the LED modules not shown is populated with a plurality of side-emitting LEDs (not shown). Heatsinks 460 are used to facilitate heat transfer from LED modules. The heatsinks 460 are slightly oversized and larger in diameter than the light diffusers 470 to better facilitate removal of heat. A larger diameter creates a larger surface area from which the heatsink can radiate heat. Additionally, the larger diameter allows heat to be radiated directly into the environment rather than into air space within the LED module. A cap 480 secures the LED modules, diffusers 470, and heatsinks 460 onto the pillar. The assembled LED bulb 400 can be somewhat similar in size and shape to a typical incandescent bulb or a typical compact fluorescent bulb.

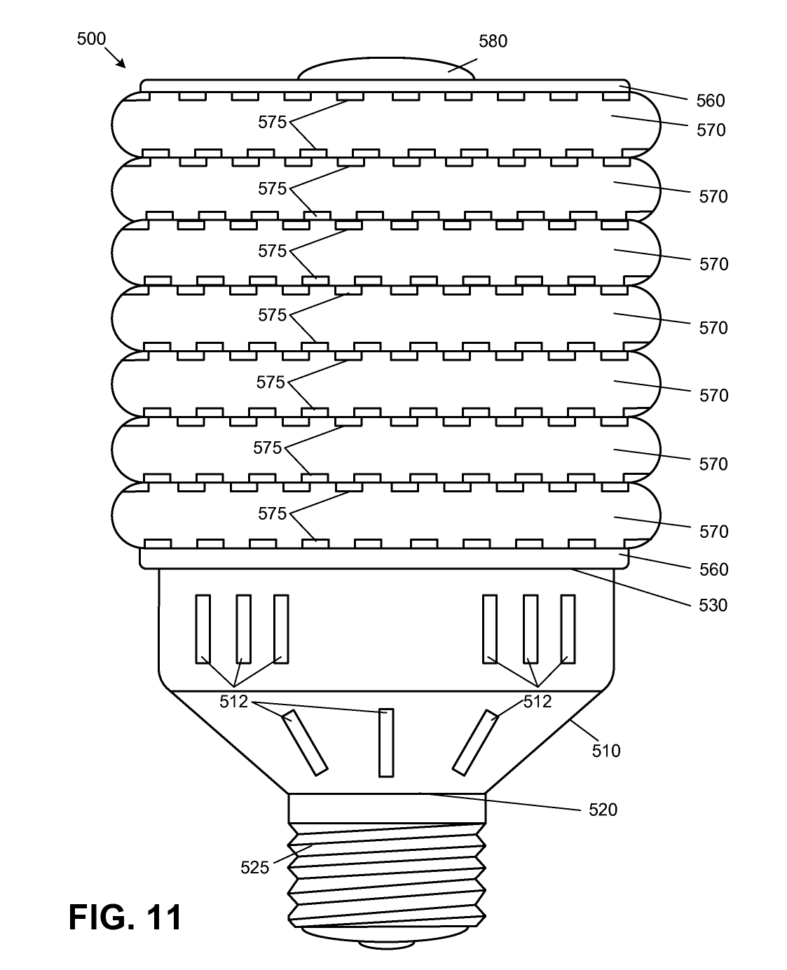

FIG. 11 is a side view of a LED bulb according to an exemplary embodiment of the invention. As shown in FIG. 11, an LED bulb 500 has a base 510 with a first surface 520, a second surface 530, and vent holes 512. An electrical connector 525 is located on the first surface 520. The electrical connector 525 can be an Edison E27 screw-in type connector. A plurality of LED modules (not shown) are stacked on the second surface 530 with a heatsink between separate pairs of LED modules behind light diffusers 570. Heatsinks (not shown) are used to facilitate heat transfer from the LED modules. The heatsinks (not shown) are obscured behind the light diffusers 570.

Light diffusers 570 cover the LED modules (not shown) and diffuse the light from the plurality of LEDs (not shown). More specifically, each of the light diffusers 570 surrounds a pair of the plurality of LED modules. The light diffusers 570 have a plurality of slotted vent holes 575, that allow air to enter into the LED bulb 500 and contact the heatsinks (not shown) so as to remove heat from the heatsinks and the LEDs.

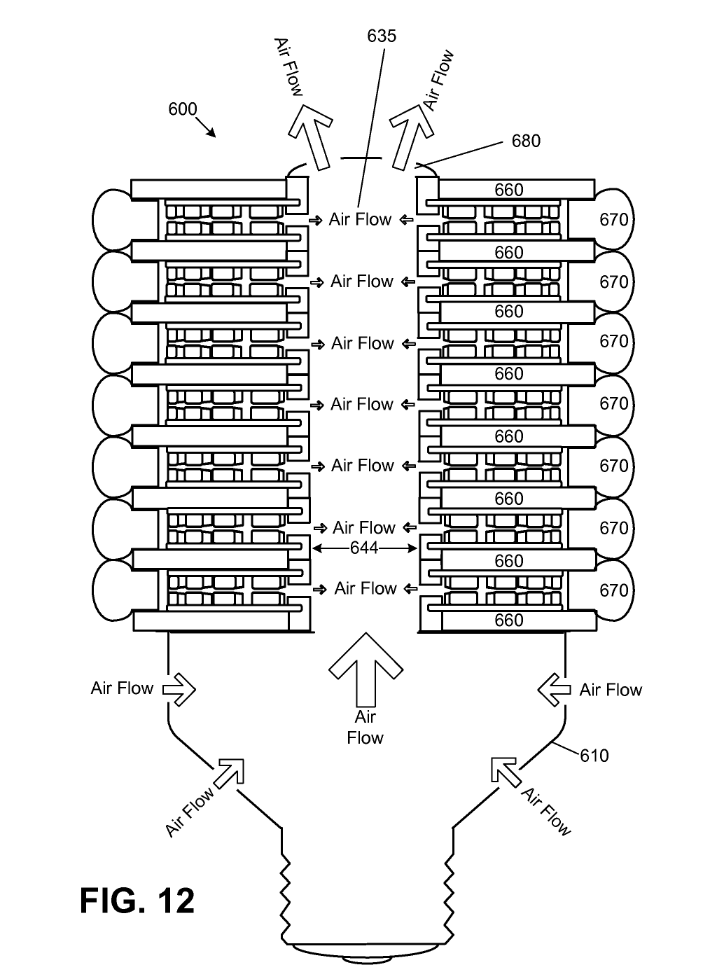

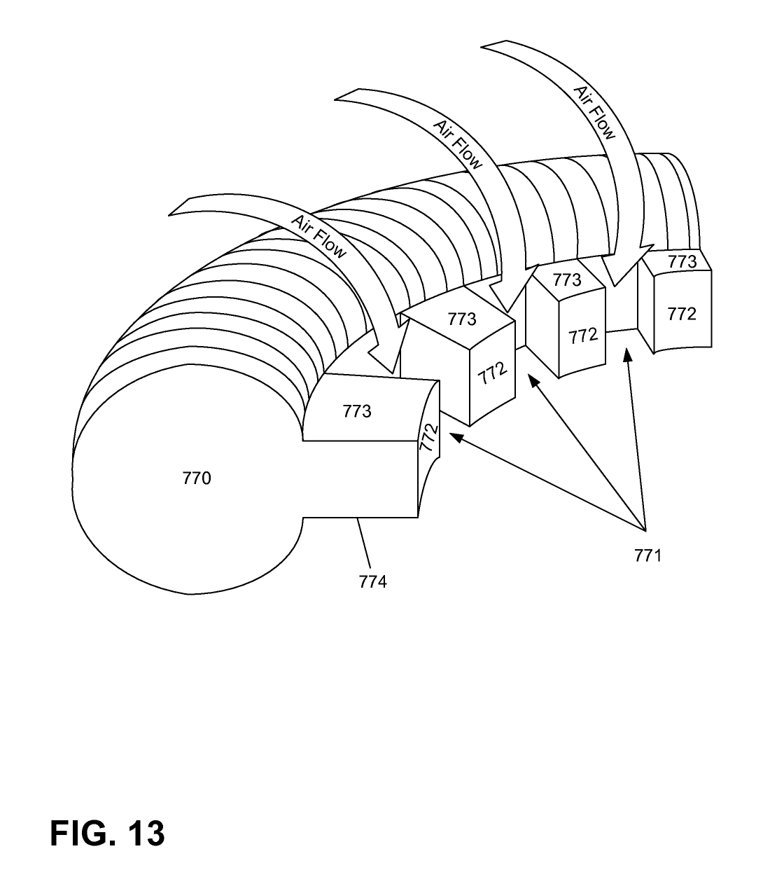

FIG. 12 is a cross-sectional view of an LED bulb showing air flow according to an exemplary embodiment of the invention. As shown in FIG. 12, the openings in the base 610 and in the cap 680 allow air movement through the base, through the hollow pillar and out the cap 680 such that the LED modules can be cooled by heat transfer through the interboard connectors 644 and heatsinks 660 to the hollow pillar 635. Although the air flow in the LED bulb 600 shown in FIG. 12 goes through the base 610 and then into the hollow pillar 635 so as to exhaust out the cap 680, the air flow would go through the cap 680, through the hollow pillar 635, and then into the base 610 if the LED bulb 600 was implemented upside down due to the convection current nature of heated air.

As shown in FIG. 12, the light diffusers 670 are oversized as to hide the heatsinks 660. The light diffusers 670 can have slots or voids to allow air to pass and cool the side-emitting LEDs of the LED bulb 600. The light diffuser can be held fast by a heatsink 660 contacting the top surface, and bottom surface of the light diffuser 670.

FIG. 13 is an isometric cross-sectional view of a light diffuser shown in FIG. 12. As shown in FIG. 13, the light diffuser 770 is rounded to match the contour of the LED bulb (not shown). The light diffuser includes voids 771 and teeth 772 as well as a top surface 773 and a bottom surface 774. The teeth 772 abut the side-emitting LEDs of LED modules and transmit light into the rest of the light diffuser 770. External air can enter the LED bulb (not shown) by passing through the voids 771 to cool the internal circuitry.

Although the preferred embodiments are disclosed having three different air flow paths, embodiments of the inventions can include combinations of the different air flow paths disclosed above. Further, an electrical fan can be provided in either the base or the cap to increase air flow. It will be apparent to those skilled in the art that other various modifications and variations can be made in embodiments of the invention without departing from the spirit or scope of the invention. Thus, it is intended that embodiments of the invention cover the modifications and variations of this invention provided they come within the scope of the appended claims and their equivalents.

What is claimed is:

1. A light emitting diode bulb, comprising:
a base member having a first surface and a second surface;
an electrical connector at the first surface of the base member;
a plurality of light emitting diode modules stacked on the second surface, wherein each of the light emitting diode modules have top surface on which a plurality of light emitting diodes are positioned and a bottom surface opposite to the top surface; and
a plurality of heatsinks positioned between every other one of the plurality of light emitting diode modules.

2. The light emitting diode bulb of claim 1, further comprising a plurality of diffusers respectively positioned between each of the plurality of heatsinks.

3. The light emitting diode bulb of claim 2, wherein the plurality of diffusers have a plurality of ventilation slots.

4. The light emitting diode bulb of claim 2, wherein the plurality of diffusers have a plurality of teeth inserted between a pair of the plurality of heatsinks.

5. The light emitting diode bulb of claim 2, wherein the plurality of heatsinks have a larger diameter than the plurality of diffusers.

6. The light emitting diode bulb according to claim 1, further comprising a hollow pillar extending from the second surface through the plurality of light emitting diode modules.

7. The light emitting diode bulb according to claim 6, wherein the base has openings such that air can flow through the base and the hollow pillar.

8. The light emitting diode bulb according to claim 6, wherein the hollow pillar has openings between the light emitting diode modules.

9. A light emitting diode bulb, comprising:
a base member having a first surface and a second surface;
an electrical connector at the first surface of the base member;
a pillar extending from the second surface of the base member;
a plurality of light emitting diode modules stacked on the base member and surrounding the pillar, wherein each of the light emitting diode modules have top surface on which a plurality of light emitting diodes are positioned and a bottom surface opposite to the top surface; and
a plurality of heatsinks respectively positioned on the bottom surfaces of pairs of the plurality of light emitting diodes.

10. The light emitting diode bulb of claim 9, further comprising a plurality of diffusers respectively positioned between each of the plurality of heatsinks.

11. The light emitting diode bulb of claim 10, wherein the plurality of diffusers have a plurality of ventilation slots.

12. The light emitting diode bulb of claim 10, wherein the plurality of diffusers have a plurality of teeth inserted between a pair of the plurality of heatsinks.

13. The light emitting diode bulb of claim 10, wherein the plurality of heatsinks have a larger diameter than the plurality of diffusers.

14. The light emitting diode bulb according to claim 10, wherein the pillar is hollow and the base has openings such that air can flow through the base and the hollow pillar.

15. The light emitting diode bulb according to claim 10, wherein the pillar is hollow and has openings between the light emitting diode modules.

16. A light emitting diode bulb, comprising:
a base member having a first surface and a second surface;
an electrical connector at the first surface of the base member;
a first light emitting diode module connected at the second surface and having a first outer periphery;
a first plurality of side-emitting light emitting diodes at the first outer periphery;
a second light emitting diode module stacked on the first light emitting diode module and having a second outer periphery;
a second plurality of side-emitting light emitting diodes at the second outer periphery and facing opposite to the first plurality of side-emitting light emitting diodes;
a first heatsink on the first light emitting diode module;
a second heatsink on the second light emitting diode module; and
a first diffuser between the first and second heatsinks.

17. The light emitting diode bulb according to claim 16, further comprising:
a third light emitting diode module on the second heatsink and having a third outer periphery;
a third plurality of side-emitting light emitting diodes at the third outer periphery;
a fourth light emitting diode module stacked on the third light emitting diode module and having a fourth outer periphery;
a fourth plurality of side-emitting light emitting diodes at the fourth outer periphery and facing opposite to the third plurality of side-emitting light emitting diodes;
a third heatsink on the fourth light emitting diode module; and
a second diffuser between the second and third heatsinks.

18. The light emitting diode bulb of claim 17, wherein the first diffuser contacts the second diffuser and has a plurality of ventilation slots.

19. The light emitting diode bulb of claim 17, wherein the first diffuser has a first plurality of teeth inserted between a the first and second heatsinks, and the second diffuser has a second plurality of teeth inserted between a the second and third heatsinks.

20. The light emitting diode bulb of claim 17, wherein the first and second heatsinks have a different diameter than the second diffuser.
